(19) United States
(12) Patent Application Publication
(10) Pub. No.: US 2013/0121022 A1
(43) Pub. Date: May 16, 2013

(54) OPTICAL SHEET HAVING IMPROVED DURABILITY, AND BACKLIGHT UNIT COMPRISING SAME

(71) Applicants: Kwang-Seung Park, Daejeon (KR); Hang-Suk Choi, Chungcheongbuk-do (KR); Jin-Kyu Kim, Chungcheongbuk-do (KR); Dong-Hwan Ryu, Chungcheongbuk-do (KR); Min-Kyun Kim, Chungcheongbuk-do (KR); Ji Hyung Lee, Seoul (KR); Sang-choll Han, Daejeon (KR); Jin-Hyun Kim, Daejeon (KR)

(72) Inventors: Kwang-Seung Park, Daejeon (KR); Hang-Suk Choi, Chungcheongbuk-do (KR); Jin-Kyu Kim, Chungcheongbuk-do (KR); Dong-Hwan Ryu, Chungcheongbuk-do (KR); Min-Kyun Kim, Chungcheongbuk-do (KR); Ji Hyung Lee, Seoul (KR); Sang-choll Han, Daejeon (KR); Jin-Hyun Kim, Daejeon (KR)

(73) Assignee: LG CHEM, LTD., Seoul (KR)

(21) Appl. No.: 13/634,146

(22) PCT Filed: Mar. 10, 2011
(86) PCT No.: PCT/KR2011/001684

§ 371 Date: Jan. 25, 2013

(30) Foreign Application Priority Data
Mar. 12, 2010 (KR) 10-2010-0022365
Feb. 21, 2011 (KR) 10-2011-0015079

(51) Int. Cl. F21V 8/00; G02B 3/00

(52) U.S. Cl. CPC G02B 6/0036; G02B 3/0075
USPC 362/607; 359/619

(57) ABSTRACT

A durability-enhanced optical sheet and an edge-type backlight unit having the optical sheet. The edge-type backlight unit includes a light source unit that includes a plurality of light sources, a light guide unit that is disposed adjacently to the light source unit and controls a path of light generated from the light source unit, a diffusion sheet disposed on the light guide plate, and an optical sheet that is disposed on the diffusion sheet and includes a lens unit and a non-lens unit, wherein the non-lens unit includes a first base unit, a second base unit, and a bonding layer for bonding the first and second base units. The optical sheet includes two base unit layers, and thus, sheet waves that can be caused due to heat can be prevented, modulus can be increased, and durability of the optical sheet can be enhanced.

### TECHNICAL FIELD

The present invention relates to a durability-enhanced optical sheet and an edge-type backlight unit having the same, and more particularly, to a structure of an optical sheet having increased durability when compared to a related-art optical sheet and an edge-type backlight unit having the same.

### BACKGROUND ART

In general, liquid crystal display (LCD) devices are electronic devices that transform electrical information generated from various devices into visual information using the change of permeability of liquid crystals according to a voltage applied to the liquid crystals. LCD devices have advantages in that they can be miniaturized and light-weighted as well as having low power consumption, and thus, have received attention as devices that can overcome the drawbacks of related-art cathode ray tubes (CRTs).

In general, LCD devices are display devices that use liquid crystal light modulation, that is, when a voltage is applied to liquid crystals in an LCD device, a specific molecular arrangement of the liquid crystals therein is transformed into another molecular arrangement. In this case, optical characteristics of the liquid crystals, such as birefringence, rotatory polarization, dichroism, and optical dispersion characteristics are changed due to variations in molecular rearrangement, and the variations of the optical characteristics of the liquid crystals are transformed into visual information. An LCD device is a non-emissive (passive type) device, and thus requires an additional light source that can illuminate the entirety of an image of the LCD device. The illumination device for an LCD device is referred to as a backlight unit.

In general, backlight units are classified into an edge-type backlight unit and a direct reflection type backlight unit. In the case of the edge-type backlight unit, a light emitting lamp is disposed to a side of a light guide-plate that guides light generated from the light emitting lamp. The edge-type backlight unit is generally used in relatively small LCD devices such as desk-top or lap-top computer monitors. The edge-type backlight unit has high light uniformity and high durability, and can be easily formed to be thin. However, direct reflection type backlight units have been developed for use in medium-sized and large display devices, and directly illuminate an entire liquid crystal panel by having a plurality of lamps arranged directly under the liquid crystal panel.

As a related art technology, a linear type light source, such as cold cathode fluorescent lamp (CCFL), has been widely used as a light emitting lamp for a backlight unit. However, recently, CCFLs have been replaced by light emitting diodes (LEDs) since LEDs have color reproducibility higher than that of CCFLs, are eco-friendly, thin, light-weight, and have low power consumption.

Backlight units for LEDs can also be classified into an edge-type backlight unit and a direct reflection type backlight unit. An advantage of the edge-type backlight unit over the direct reflection type backlight unit is that the edge-type backlight unit can be formed to be thinner than the direct reflection type backlight unit. However, in the case of the edge-type backlight unit, a large amount of heat is generated from an organic light emitting diode, and in particular, since an optical sheet is disposed immediately adjacent to the light emitting diode which is a light source in the structure of the edge-type backlight unit, when a related art optical sheet is applied directly to the edge-type backlight unit, waves can occur in the optical sheet, thereby causing deformation of the optical sheet.

Currently, a great deal of research and development has been conducted with the technical goal of achieving thin, light-weight backlight units, and in particular, the development of a non-deformable durability-enhanced optical sheet is required.

### DISCLOSURE

### Technical Problem

An aspect of the present invention provides a durability-enhanced optical sheet.

Another aspect of the present invention provides an edge-type backlight unit having a durability-enhanced optical sheet.

### Technical Solution

According to an aspect of the present invention, there is provided an optical sheet including a lens unit and a non-lens unit, wherein the non-lens unit includes a first base unit, a second base unit, and a bonding layer for bonding the first and second base units.

According to another aspect of the present invention, there is provided an edge-type backlight unit including a light source unit; a light guide unit that is disposed adjacently to the light source unit and controls a path of light generated from the light source unit; a diffusion sheet disposed on a light emitting plane of the light guide plate; and an optical sheet that is disposed on the diffusion sheet, and includes a lens unit and a non-lens unit, wherein the non-lens unit includes a first base unit, a second base unit, and a bonding layer for bonding the first and second base units.

The bonding layer may be formed of an ultraviolet (UV) curable resin.

The bonding layer and the first and second base units may have a thickness direction refractive index difference within 0.02.

The bonding layer may have a refractive index in a range from about 1.49 to about 1.6.

The lens unit may have a prism shape, a lenticular shape, a micro-lens array (MLA) shape, a polygonal pyramid shape, or a conical shape.

The first and second base units may be formed of a material selected from the group consisting of polyethylene terephthalate (PET), polypropylene (PP), polycarbonate (PC), polyethylene naphthalate (PEN), and polymethyl-methacrylate (PMMA).

The first and second base units may be bonded so that a machine direction (MD) and a transverse direction (TD) of the first and second base units are parallel to each other.

The first and second base units may be bonded so that an MD and a TD of the first and second base units are perpendicular to each other.

The light source unit may be a light emitting diode (LED).

The backlight unit may include at least two optical sheets.

### Advantageous Effects

The optical sheet of the present invention includes two base unit layers, and thus, sheet waves that may be caused due to heat can be prevented, modulus can be increased, and durability of the optical sheet can be enhanced.

### DESCRIPTION OF DRAWINGS

The above and other aspects, features and other advantages of the present invention will be more clearly understood from the following detailed description taken in conjunction with the accompanying drawings, in which:

FIG. 1 is a schematic cross-sectional view of an exemplary optical sheet according to an embodiment of the present invention;

FIG. 2 is a schematic cross-sectional view of an edge-type backlight unit having an exemplary optical sheet according to an embodiment of the present invention;

FIGS. 3 (a) and 3 (b) are scanning electron microscope (SEM) photos of a related-art PET sheet and an optical sheet according to an embodiment of the present invention;

FIGS. 4 (a) and 4 (b) are graphs showing the variation of an optical sheet according to time when a predetermined tension is applied to the optical sheet according to an embodiment of the present invention in mechanical and transverse directions;

FIGS. 5 (a) and 5 (b) are graphs showing the variation of an optical sheet according to temperature when a predetermined tension is applied in mechanical direction and transverse directions to the optical sheet according to an embodiment of the present invention;

FIG. 6 shows a comparison of optical characteristics as a result of the application of an optical sheet according to an embodiment of the present invention;

FIG. 7 shows a high temperature driving test result of a light emitting diode television using an optical sheet according to an embodiment of the present invention; and

FIG. 8 shows a high temperature driving test result of a light emitting diode television using a related-art optical sheet according to an embodiment of the present invention.

### BEST MODE

Exemplary embodiments of the present invention will now be described in detail with reference to the accompanying drawings.

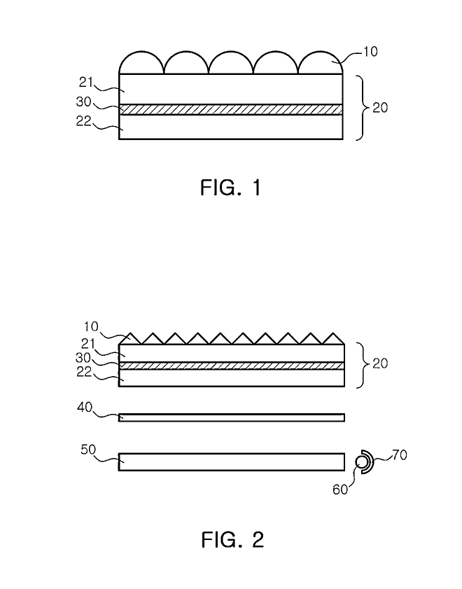

According to an aspect of the present invention, a durability-enhanced optical sheet is provided. FIG. 1 is a schematic cross-sectional view of an exemplary optical sheet according to an embodiment of the present invention. The optical sheet includes a lens unit 10 and a non-lens unit 20. The non-lens unit 20 includes a first base unit 21, a second base unit 22, and a bonding layer 30 to bond the first and second base units 21 and 22. FIG. 2 is a schematic cross-sectional view of an edge-type backlight unit having an exemplary optical sheet according to an embodiment of the present invention.

The lens unit 10 is formed on a surface of the first base unit 21 through which light is emitted. The lens unit 10 may have a prism shape, a lenticular shape, a micro-lens array (MLA) shape, a polygonal pyramid shape including a triangular pyramid and a quadrangular pyramid, or a conical shape; however, the current embodiment is not limited thereto. For example, in FIG. 1, the optical sheet includes the lens unit 10 having a lenticular shape.

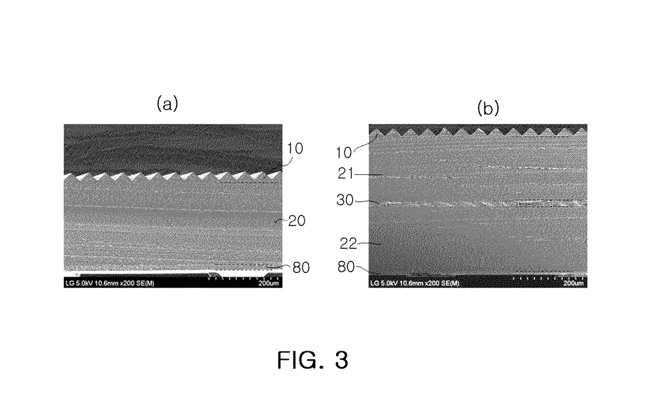

Meanwhile, the non-lens unit 20 is disposed on a surface of the lens unit 10 through which light enters. The non-lens unit 20 includes the first base unit 21 and the second base unit 22 bonded to each other by the bonding layer 30. In order to confirm a structural difference between a related-art PET sheet and the optical sheet according to the present invention, scanning electron microscope (SEM) images are taken. FIGS. 3(a) and 3(b) are SEM photos of a cross-section of a related-art PET sheet formed of a single base unit and a cross-section of the optical sheet having the first and second base units 21 and according to an embodiment of the present invention. The related-art PET sheet may include the non-lens unit 20 formed of a single layer, the lens unit 10 disposed on the non-lens unit 20, and a back coating layer 80 on a lower surface of the non-lens unit 20. However, the optical sheet according to the present invention may include the non-lens unit 20 having the first base unit 21 and the second base unit 22 combined to each other by the bonding layer 30, the lens unit 10 on an upper surface of the non-lens unit 20, and the back coating layer 80 on a lower surface of the non-lens unit 20.

In order to prevent waves in the optical sheet caused due to heat, the thickness of the optical sheet may be increased. However, when the thickness of the optical sheet is increased, optical characteristics of the optical sheet may be reduced and the manufacturing of the optical sheet may be difficult. For example, in the case of a polyethylene terephthalate (PET) sheet, PET sheets having a thickness of 250 μm are generally commercialized. Although PET sheets having a thickness of about 300 μm may be manufactured, the quantity thereof is low. However, according to the present invention, an optical sheet that can maintain optical characteristics and has increased durability with increased thickness can be manufactured by forming a non-lens unit that includes first and second base units bonded to each other.

That is, according to the present invention, an optical sheet including the first and second base units 21 and 22 is provided, and a light emitting surface of the first base unit 21 may be disposed to contact the lens unit 10. The first and second base units 21 and 22 may have respective thicknesses in a range from about 125 μm to about 250 μm, and the bonding layer 30 formed between the first and second base units 21 and 22 may have a thickness in a range from about 1 μm to about 20 μm, and more specifically, 10 μm. Accordingly, an overall thickness of the optical sheet except for the lens unit 10 and the back coating layer 80 may be in a range from about 251 μm to about 520 μm.

If the first and second base units 21 and 22 have respective thicknesses of less than 125 μm, the wave improvement is reduced. In particular, in the case of the PET sheet, a film having a semi-crystalline state is obtained by orienting a material having an amorphous state in a machine direction (MD) and a transverse direction (TD). Therefore, it is difficult for a PET film having a thickness greater than 250 μm to have a semi-crystalline state of a uniform quality, and accordingly, it is difficult to maintain the inherent characteristics thereof. Therefore, when the thickness of the PET sheet exceeds 250 μm, a commercial supply thereof is difficult. Furthermore, when two PET sheets are laminated, the thickness of an optical sheet is excessively increased. Accordingly, in the application of a process that uses a roll, the optical sheet may not be wound on the roll.

The bonding layer 30 that combines the first and second base units 21 and 22 may be formed of an ultraviolet (UV) curable resin. When UV rays are irradiated onto the UV curable resin, optical initiators of the UV curable resin initiate a polymerization reaction by UV energy, and then, monomers and oligomers, which are the main components of the UV curable resin, are instantly polymerized. The UV curable resin that can be used in the current embodiment may be one selected from the group consisting of an epoxy acrylate group, a polyester acrylate group, and a urethane acrylate group.

However, in manufacturing the bonding layer 30, when a thermal curing adhesive is used, a curing time is required, when a thermo-plastic adhesive is used, an optical sheet may be damaged due to a high temperature process, and when a pressure sensitive adhesive (PSA) is used, the PSA has a relatively slow lamination velocity. Therefore, in the current embodiment, the bonding layer 30 may be formed of the UV curable resin, and in this case, productivity can be increased. Meanwhile, since the PSA that can be cured by UV rays generates an odor, the PSA cannot be applied to a mass production process.

In the current specification, the terms ‘adhesion’ and ‘bond’ are distinguishably used. ‘Adhesion’ generally denotes that elements are easily attachable and detachable to and from each other, and that elements can be reattached to each other. However, the ‘bond’ denotes that once elements are attached to each other, detachment is difficult, and once elements are detached from each other, the reattachment thereof is difficult.

In the current embodiment, the first and second base units 21 and 22 included in the non-lens unit 20 may be formed of a material selected from the group consisting of polyethylene terephthalate (PET), polypropylene (PP), polycarbonate (PC), polyethylene naphthalate (PEN), polymethyl-methacrylate (PMMA), and a mixture of these materials, and more particularly, may be formed of polyethylene terephthalate (PET). Meanwhile, the first and second base units 21 and 22 may be formed of materials different from each other. However, in this case, there is a possibility that a distortion can occur or the effect of the optical sheet can be reduced. Therefore, the first and second base units 21 and 22 may be formed of the same material in consideration of ease of processability.

The bonding layer 30 may have a thickness direction refractive index equal to or within a difference of 0.02 from those of the first and second base units 21 and 22. The bonding layer 30 may have a refractive index greater or smaller than that of the first and second base units 21 and 22 within the above range. Optical loss due to reflection at an interface between the first and second base units 21 and 22 and the bonding layer 30 can be minimized by adjusting the difference of the thickness direction refractive index of the bonding layer 30 and the thickness direction refractive indexes of the first and second base units 21 and 22 within 0.02.

The typical thickness direction refractive index of polyethylene terephthalate (PET) is in a range from 1.49 to 1.51, that of PP is in a range from 1.49 to 1.51, that of PC is in a range from 1.58 to 1.60, that of PEN is in a range from 1.64 to 1.65, and that of PMMA is in a range from 1.49 to 1.50.

Accordingly, for example, when the first and second base units 21 and 22 are formed of PET, since PET has a thickness direction refractive index in a range from 1.49 to 1.51, the bonding layer 30 may be formed to have a thickness direction refractive index in a range from 1.47 to 1.53. However, a material having a refractive index smaller than 1.49 is relatively expensive and has a low level of mechanical strength which can cause a reduction of physical properties of the optical sheet. Thus, the bonding layer 30 may have a thickness direction refractive index greater than 1.49.

In the current embodiment, the optical loss due to reflection at an interface is minimal when the first and second base units 21 and 22 included in the non-lens unit 20 are formed of the same material and the bonding layer 30 used between the first and second base units 21 and 22 has a refractive index equal to those of the first and second base units 21 and 22.

The refractive index of the bonding layer 30 may be attained by transforming a molecular structure in a resin used to form the bonding layer 30. For example, in manufacturing a bonding agent for forming the bonding layer 30, when an acrylate that contains an aromatic compound such as benzene or naphthalene is used, the refractive index can be increased to 1.6 after curing the bonding layer 30. Although an aromatic compound is not included, the refractive index of the bonding layer 30 can be increased up to approximately 1.54 by controlling molecular weight or cross-linking the density of molecules. In the current embodiment, it is found that the use of a refractive index in a range from 1.51 to 1.54 after curing is optically advantageous and economical.

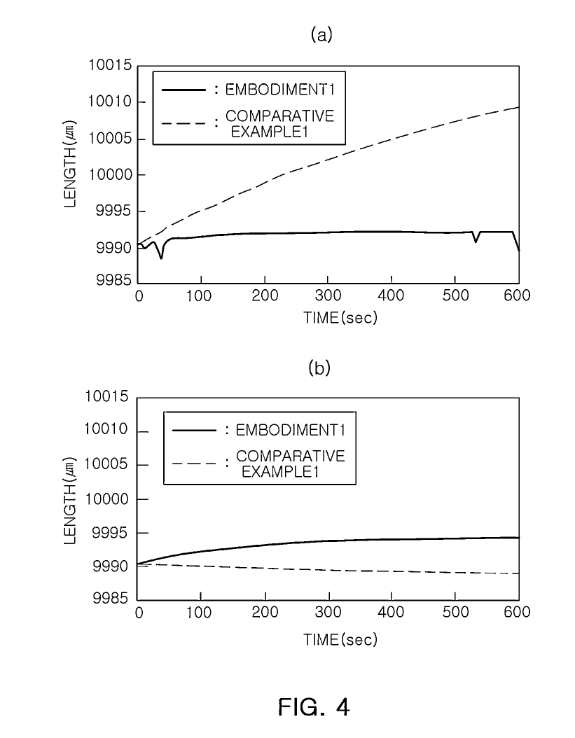

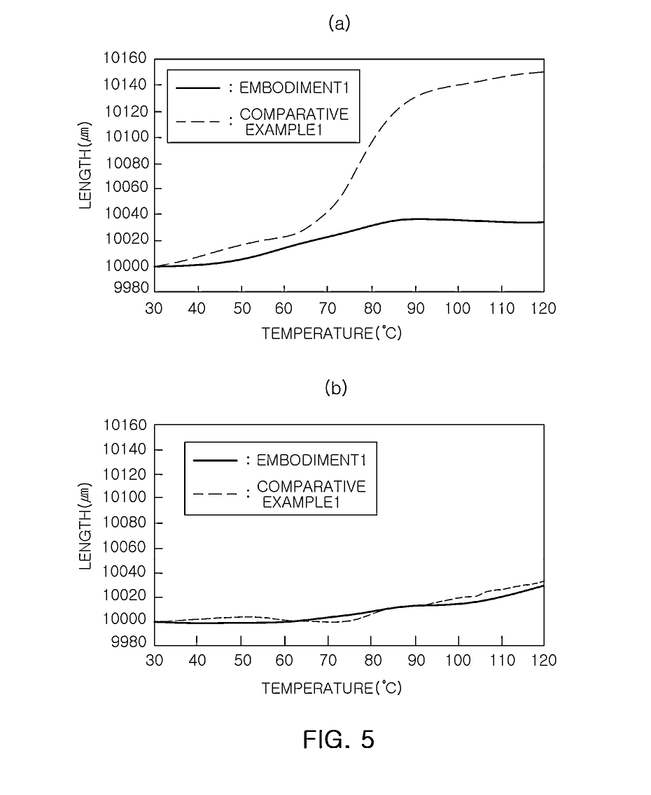

As shown in an embodiment and in FIGS. 4 and 5, the first and second base units 21 and 22 included in the non-lens unit 20 of an optical sheet according to the present invention may have different physical properties in an MD and a TD. The first and second base units 21 and 22 may be bonded so that the MD and TD can be matched to each other or the MD and the TD can be perpendicular to each other. However, when the first and second base units 21 and 22 are bonded so that the MD and the TD are perpendicular to each other, the bonding layer 30 may have sufficient elasticity to absorb different physical properties in the MD and the TD. If the bonding layer 30 does not have sufficient elasticity, the bonding layer 30 can be distorted due to residual stresses in different directions in each of the first and second base units 21 and 22.

Meanwhile, the back coating layer 80 may be formed on an optical incident surface of the second base unit 22 of the optical sheet according to the present invention to prevent the optical sheet from being scratched or being in tight contacted with another optical sheet. The back coating layer 80 may be formed of a thermal curing resin or an UV curable resin. If necessary, beads formed of PMMA, polybutylmethacrylate (PBMA), or nylon can be used.

The optical sheet according to the present invention may be readily manufactured by using a method well known in the art. For example, in order to form a non-lens unit, the UV curable resin described above is provided on a surface of a sheet that constitutes a first base unit, and a second base unit is attached to the surface of the sheet. Subsequently, the surface of the sheet is planarized by using a roll pressing method and the thickness of the sheet is controlled by maintaining a gap, having a predetermined distance, between the rolls, and thus, the non-lens unit having the first base unit, a bonding layer that is not cured, and the second base unit can be obtained. Subsequently, the bonding layer is cured by irradiating UV rays having an intensity in a range from about 300 to about 2000 mJ/cm² onto the non-lens unit that includes the bonding layer that is not cured. As a result, a non-lens unit in which the first base unit and the second base unit are bonded to each other by the bonding layer can be formed.

Afterwards, in order to form the lens unit 10 that constitutes an optical sheet according to the present invention, after placing a mold on which a lens shape is engraved on the first base unit 21, the engraved lens shape is filled with a curing resin solution. When the curing resin is cured, a lens unit can be formed. At this point, the curing resin may be one selected from the group consisting of an epoxy acrylate group, a poly ester acrylate group, and a urethane acrylate group, and may be the same as or different from a resin used to form the first and second base units 21 and 22.

When the lens unit 10 is formed, generally, the lens unit 10 may be formed by using a UV curable resin and an engraved mold. Also, an optical sheet that includes a lens unit may be formed such that, after coating a resin composition, in which a UV curable resin, a thermo setting resin, and a solvent are mixed, on a base unit at a predetermined thickness, the solvent is removed by heating the coating in a heat chamber, and then, the coating is thermally cured. Afterwards, the shape of a lens unit is formed by pressing the resultant coating with an engraved mold, and then, the lens unit is finally UV cured.

At this point, lens units having various shapes, heights, and pitches can be formed by using molds in which various lens unit shapes are engraved. Besides the above, various methods of manufacturing optical sheets are well known in the art, and thus, the optical sheet according to the present invention may be formed by using a related-art method other than the method described above.

According to an aspect of the present invention, there is provided a backlight unit having an optical sheet according to the present invention. FIG. 2 is a schematic cross-sectional view of an edge-type backlight unit having an exemplary optical sheet according to an embodiment of the present invention.

Referring to FIG. 2, the edge-type backlight unit includes: a light source unit 60 that includes a plurality of light sources; a reflection plate 70 that surrounds the light source unit 60; a light guide plate 50 that is disposed adjacently to the light source unit 60 and controls a path of light generated from the light source unit 60; a diffusion sheet 40 disposed on a light emission surface of the light guide plate 50; and an optical sheet that is disposed on the diffusion sheet, and includes a lens unit 10 and a non-lens unit 20, wherein the non-lens unit 20 includes a first base unit 21, a second base unit 22, and a bonding layer 30 for bonding the first and second base units 21 and 22.

The backlight unit according to the present invention is driven by an edge-light method in which the light source unit 60 can be disposed on a side or multiple sides of the light guide plate 50. The light source unit 60 may include, for example, an LED.

The backlight unit according to the present invention may include the reflection plate 70. Light emitted from the light source unit 60 enters the light guide plate 50 through a side plane, that is, a light incident plane of the light guide plate 50. At this point, the reflection plate 70 may increase the efficiency of light that enters to the light guide plate 50 by reflecting light generated from the light source unit 60 towards the light guide plate 50.

The light guide plate 50 controls a path of light generated from the light source unit 60. The light guide plate 50 transmits light that enters the light guide plate 50 through a light incident plane disposed on a side thereof in a direction substantially parallel to a viewing plane of a liquid crystal panel disposed on the light guide plate 50, and uniformizes the light. A front surface of the light guide plate 50 is a light emitting plane through which light emits in a direction in which the liquid crystal panel is disposed.

Meanwhile, a reflection sheet may be disposed on a rear surface of the light guide plate 50, and the reflection sheet reflects light emitted towards the rear surface of the light guide plate 50 towards the light guide plate 50.

An optical sheet may be disposed between the light guide plate 50 and the liquid crystal panel to increase brightness by focusing light emitted from the light guide plate 50 in a direction substantially perpendicular to a viewing plane of the liquid crystal panel.

The optical sheet that can be used in the current embodiment may include the lens unit 10 for transforming a path of light incident from the light guide plate 50 and the non-lens unit 20 for supporting the lens unit 10. Meanwhile, the optical sheet that can be included in the backlight unit according to the present invention may include the lens unit 10 and the non-lens unit 20 that includes the first and second base units 21 and 22 which are bonded to each other via the bonding layer 30 as described above.

The lens unit 10 of the optical sheet is formed on a light emitting plane of the first base unit 21. The lens unit 10 may have a prism shape, a lenticular shape, a MLA shape, a polygonal pyramid shape including a triangular pyramid shape and a quadrangular pyramid shape, or a conical shape, but the current embodiment is not limited thereto.

In practical applications, the first and second base units 21 and 22 of the optical sheet are disposed to face the light guide plate 50, and a light path is directed in a direction substantially perpendicular to a viewing plane of the liquid crystal panel.

The first and second base units 21 and 22 may have respective thicknesses in a range from about 125 μm to about 250 μm, and the bonding layer 30 may have a thickness in a range from about 1 μm to about 20 μm. Accordingly, an overall thickness of the optical sheet except for the lens unit 10 and the back coating layer 80 may be in a range from about 251 μm to about 520 μm.

The bonding layer 30 may be formed of an ultraviolet (UV) curable resin. The UV curable resin that can be used in the current embodiment may be one selected from the group consisting of an epoxy acrylate group, a polyester acrylate group, and a urethane acrylate group.

In the current embodiment, the first and second base units 21 and 22 that constitute the non-lens unit 20 may be formed of a material selected from the group consisting of PET, PP, PC, PEN, PMMA, and a mixture of these materials, and more particularly, may be formed of PET. Meanwhile, the first and second base units 21 and 22 may be formed of materials different from each other. However, the first and second base units 21 and 22 may be formed of the same material in consideration of ease of processability.

The bonding layer 30 may have a thickness direction refractive index equal to or within a difference of 0.02 of those of the first and second base units 21 and 22. The refractive index of the bonding layer 30 may be controlled by transforming a molecular structure in a resin that is used to form the bonding layer 30. For example, when the bonding layer 30 is formed of acrylate that contains an aromatic compound such as benzene or naphthalene, the refractive index can be increased to 1.6. Although an aromatic compound is not included, the refractive index of the bonding layer 30 can be increased up to approximately 1.54 by controlling molecular weight or increasing cross-linking density of molecules.

The first and second base units 21 and 22 that constitute the non-lens unit 20 of an optical sheet according to the present invention may have different physical properties in an MD and a TD. The first and second base units 21 and 22 may be bonded so that the MD and TD can be parallel to each other or perpendicular to each other.

Meanwhile, the back coating layer 80 may be formed on a light incident plane of the second base unit 22 of the optical sheet according to the present invention. The back coating layer 80 may be formed of a thermal curing resin, a UV curable resin, or as necessary, beads of PMMA, PBMA, or nylon.

The backlight unit according to the present invention may include at least two optical sheets described above, or may include one optical sheet or two optical sheets. When the backlight unit includes multiple numbers of optical sheets, the optical sheets may be disposed to cross each other with an angle of 90°.

Hereinafter, the present invention will now be described in detail through practical embodiments. However, the following embodiments are examples for describing the present invention, and thus, the present invention is not limited to the embodiments set forth herein.

### Mode for Invention

### Embodiment

### Manufacturing Example 1

An acrylate type UV curable resin bonding agent was used for manufacturing an optical sheet according to the present invention. The commercial name of the bonding agent was LK222 (a Cytec product) which has the following composition as shown in Table 1:

TABLE 1

| | Content | Refractive index |
|---|---|---|
| Composition | (weight %) | before curing |
| Alphatic urethane 1 | 30 | 1.49 |
| Alphatic urethane 2 | 30 | 1.49 |
| Multifunctional | 5 | 1.50 |
| polyester acrylate | | |
| Monofunctional monomer 1 | 10 | 1.46 |
| Monofunctional monomer 2 | 10 | 1.46 |
| Difunctional monomer | 10 | 1.46 |
| Photoinitiator & | 5 | 1.46 |
| stabilizer | | |

The refractive index of the bonding agent having the above composition before curing was 1.476±0.005, and the final refractive index after curing was 1.501±0.005.

### Example 1

In order to manufacture an optical sheet according to the present invention, an acrylate type UV curable resin was provided on a PET sheet having a thickness of 188 μm (refractive indices of 1.50 in a thickness direction and 1.64˜1.67 in a plane direction). Subsequently, after attaching a PET sheet having a thickness of 188 μm to the acrylate type UV curable resin, the resultant structure was planarized by using a roll pressing method, and the thickness of the resultant structure was controlled by maintaining a predetermined gap between the rolls, and thus, a bonding layer that is not cured was obtained on a first base unit. At this point, the resin and the rolls were maintained at a temperature of 70° C. Afterwards, a non-lens unit in which a first and second base units that are bonded using the bonding layer was obtained by irradiating UV rays with an intensity of 1,000 mJ/cm² to the bonding layer. Next, after placing a mold on which a lens shape is engraved on the first base unit, an acrylate type UV curable resin solution having a high refractive index was filled in the engraved mold. Thus, a lens unit was formed by curing the acrylate type UV curable resin.

FIG. 3(b) is a SEM image of a cross-section of the optical sheet according to Example 1 of the present invention.

### Comparative Example 1

A PET sheet (V6000 250 μm, SKC) having a thickness of 250 μm was used as a control. FIG. 3(a) is a SEM image of a cross-section of a PET sheet according to comparative example 1.

### Experimental Example 1

### Comparison of Thermal Characteristics of Optical Sheets According to Time

Behaviors of specimens according to time were observed in an MD and a TD while the optical sheet specimens of Example 1 and Comparative Example 1 were expanding at a temperature of 60° C. with a force of 0.02 N.

The results are shown in FIGS. 4(a) and 4(b). Referring to FIGS. 4(a) and 4(b), in the case of MD(a), the specimen of the optical sheet according to Comparative Example 1 showed continuous variation according to time. However, the specimen of the optical sheet according to Example 1 showed no variation at a certain level. However, in the case of the optical sheet according to Comparative Example 1, it can be assumed that the characteristics of a product can change according to time in a high temperature environment. However, the stability of the optical sheet according to Example 1 may be continuously maintained in a high temperature environment. However, both the optical sheets showed an insignificant difference in the TD(b) when compared to the MD(a).

### Experimental Example 2

### Comparison of Thermal Characteristics of Optical Sheets According to Temperature

Behaviors of specimens according to temperature were observed in an MD and a TD while the optical sheet specimens of Example 1 and Comparative Example 1 respectively were expanding with a force of 0.02 N.

The results are shown in FIGS. 5(a) and 5(b). Referring to FIGS. 5(a) and 5(b), in the case of the MD(a), the optical sheet according to Comparative Example 1 showed a sudden change at a temperature near Tg (PET 70˜80° C.) when compared to the optical sheet according to Example 1. That is, it is confirmed that the optical sheet according to Comparative Example 1 shows a sudden change according to temperature due to a minor external condition; however, the optical sheet according to Example 1 shows a relatively small change. However, both the optical sheets showed an insignificant difference in the TD (b) when compared to the MD (a).

### Comparative Example 2

As a Comparative Example 2, a sheet structure having a first diffusion sheet (SKC, CH403), a focusing film (3M, BEF III), and a second diffusion sheet (Shinwha Int. Tech., SP545) was formed.

### Example 2

A sheet structure according to Example 2 was formed by perpendicularly disposing two optical films manufactured in Example 1.

### Example 3

As another embodiment of the present invention, a sheet structure according to Example 3 was formed using a diffusion sheet (SKC, CH403), an optical film manufactured in Example 1, and a focusing film (MLF, Shinwha Int. Tech. PTR863H).

### Experimental Example 3

### Luminance Comparison

The luminance of each of the optical sheets manufactured according to Comparative Example 2, Example 2, and Example 3 was measured in a direction perpendicular to an image on a 32″ LCD TV (LG display Co.) on the basis of BLU using a BM7 from Topcon Co.

The luminance of Comparative Example 2 was 507 (100%), while that of Example 2 was 517.1 (102%), and that of Example 3 was 496.9 (98%). From this result, it was confirmed that the optical sheet according to the present invention does not cause a luminance reduction.

### Experimental Example 4

### Comparison of Horizontal and Vertical Viewing Angles

Horizontal and vertical viewing angles of the optical sheets manufactured according to Comparative Example 2, Example 2, and Example 3 were measured on the basis of BLU on a 32″ LCD TV (LG Display Co.) using EZ contrast of ELDIM Co. and BM7 of Topcon Co. Viewing angles were primarily measured by obtaining a contour line chart using the EZ contrast, and the viewing angles were re-confirmed by obtaining luminance in every angle using the BM7.

The horizontal viewing angles of Comparative Example 2, Example 2, and Example 3 were respectively 39.5, 38.5, and 38.5, and the vertical viewing angles were respectively 31, 31.5, and 35.5. From this result, it can be confirmed that the optical sheet according to the present invention do not have reduced optical characteristics when compared to a related-art configuration, and shows that there is no significant optical difference despite the increased thickness of the optical sheet.

### Experimental Example 5

### Comparison of Optical Profiles and Images

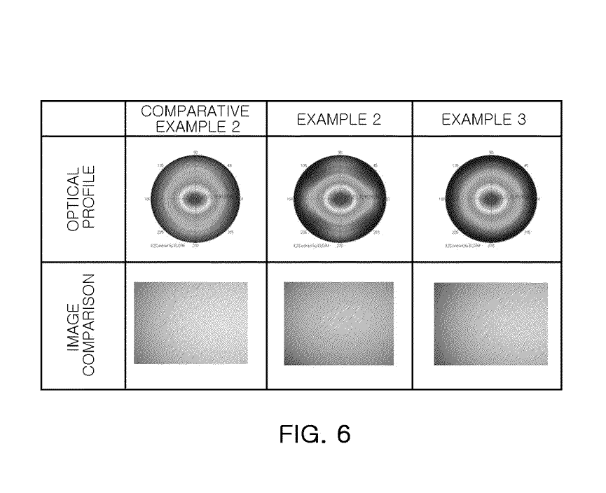

In order to compare optical profiles and images of the sheet structures manufactured in Comparative Example 2, Example 2, and Example 3, the optical profiles of the sheet structures were obtained by using EZ contrast from ELDIM Co., and the images were obtained by using a digital camera after displaying a white image on an LCD TV. The results are shown in FIG. 6.

As seen in FIG. 6, when the optical sheets of the Embodiments 2 and 3 according to the present invention are compared to that of Comparative Example 2, it is confirmed that the optical sheets according to the present invention do not reduce the optical profiles and image characteristics.

### Experimental Example 6

### High Temperature Driving Test of an LED Television Having Optical Sheet

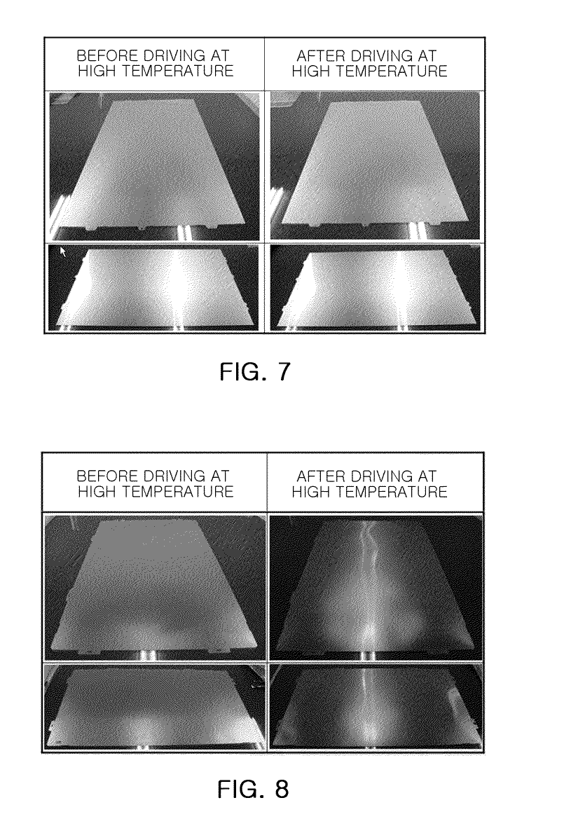

After assembling an LED television with an optical sheet of Example 1, the LED television was turned on and a high temperature driving test was performed by placing the LED television at a temperature of 65° C. for 1,000 hours. As shown the result in FIG. 7, no defect was observed in the optical sheet according to the present invention.

Meanwhile, after assembling an LED television with an optical sheet according to Comparative Example 1, the LED television was turned on and a high temperature driving test was performed by placing the LED television in a temperature of 65° C. for 1,000 hours. As shown the result in FIG. 8, waves were observed in the optical sheet of Comparative Example 1.

While the present invention has been shown and described in connection with the exemplary embodiments, it will be apparent to those skilled in the art that modifications and variations can be made without departing from the spirit and scope of the invention as defined by the appended claims.

### SEQUENCE LIST TEXT

10: lens unit
20: non-lens unit
21: first base unit
22: second base unit
30: bonding layer
40: diffusion sheet
50: Light guide plate
60: Light source unit
70: Reflection plate
80: Back coating layer

1. An optical sheet comprising:
a lens unit; and
a non-lens unit,
wherein the non-lens unit comprises a first base unit, a second base unit, and a bonding layer for bonding the first and second base units.

2. The optical sheet of claim 1, wherein the bonding layer is formed of an ultraviolet (UV) curable resin.

3. The optical sheet of claim 1, wherein the bonding layer and the first and second base units have a thickness direction refractive index difference within 0.02.

4. The optical sheet of claim 1, wherein the bonding layer has a refractive index in a range from 1.49 to 1.6.

5. The optical sheet of claim 1, wherein the lens unit has a prism shape, a lenticular shape, a micro-lens array (MLA) shape, a polygonal pyramid shape, or a conical shape.

6. The optical sheet of claim 1, wherein the first and second base units are formed of a material selected from the group consisting of polyethylene terephthalate (PET), polypropylene (PP), polycarbonate (PC), polyethylene naphthalate (PEN), and polymethyl-methacrylate (PMMA).

7. The optical sheet of claim 1, wherein the first and second base units have a thickness in a range from 125 μm to 250 μm, and the bonding layer has a thickness in a range from 1 μm to 20 μm.

8. The optical sheet of claim 1, wherein the first and second base units are bonded so that a machine direction (MD) and a transverse direction (TD) of the first and second base units are parallel to each other.

9. The optical sheet of claim 1, wherein the first and second base units are bonded so that an MD and a TD of the first and second base units are perpendicular to each other.

10. An edge-type backlight unit comprising:
a light source unit;
a light guide unit that is disposed adjacently to the light source unit and controls a path of light generated from the light source unit;
a diffusion sheet disposed on the light guide plate; and
an optical sheet that is disposed on the diffusion sheet, and includes a lens unit and a non-lens unit, wherein the non-lens unit includes a first base unit, a second base unit, and a bonding layer for bonding the first and second base units.

11. The edge-type backlight unit of claim 10, wherein the bonding layer is formed of an ultraviolet (UV) curable resin.

12. The edge-type backlight unit of claim 10, wherein the bonding layer and the first and second base units have a thickness direction refractive index difference within 0.02.

13. The edge-type backlight unit of claim 10, wherein the bonding layer has a refractive index in a range from 1.49 to 1.6.

14. The edge-type backlight unit of claim 10, wherein the lens unit has a prism shape, a lenticular shape, a MLA shape, a polygonal pyramid shape, or a conical shape.

15. The edge-type backlight unit of claim 10, wherein the first and second base units are formed of a material selected from the group consisting of polyethylene terephthalate (PET), polypropylene (PP), polycarbonate (PC), polyethylene naphthalate (PEN), and polymethyl-methacrylate (PMMA).

16. The edge-type backlight unit of claim 10, wherein the first and second base units have a thickness in a range from 125 μm to 250 μm, and the bonding layer has a thickness in a range from 1 μm to 20 μm.

17. The edge-type backlight unit of claim 10, wherein the first and second base units are bonded so that an MD and a TD of the first and second base units are parallel to each other.

18. The edge-type backlight unit of claim 10, wherein first and second base units are bonded so that an MD and a TD of the first and second base units are perpendicular to each other.

19. The edge-type backlight unit of claim 10, wherein the light source unit is light emitting diode (LED).

20. The edge-type backlight unit of claim 10, wherein the backlight unit comprises at least two optical sheets.
